(19) United States
(12) Patent Application Publication
(10) Pub. No.: US 2022/0316655 A1
(43) Pub. Date: Oct. 6, 2022

(54) HIGH PRESSURE TANK AND METHOD FOR MANUFACTURING SAME

(71) Applicant: HONDA MOTOR CO., LTD., Tokyo (JP)

(72) Inventors: Yusuke TSUCHIYAMA, WAKO-SHI (JP); Kosuke TATSUSHIMA, WAKO-SHI (JP)

(21) Appl. No.: 17/681,798

(22) Filed: Feb. 27, 2022

(30) Foreign Application Priority Data
Mar. 31, 2021 (JP) 2021-061641

(51) Int. Cl. F17C 1/16

(52) U.S. Cl. CPC F17C 1/16; F17C 2223/035; F17C 2203/0604; F17C 2203/0665; F17C 2203/012; F17C 2201/0109; F17C 2209/2154; F17C 2221/012; F17C 2270/0184; F17C 2203/0624; F17C 2203/066

(57) ABSTRACT

A high pressure tank is provided with a reinforcement layer. The reinforcement layer is provided with an inner laminated section, an outer laminated section, and an intermediate laminated section. The inner laminated section includes a winding start of an impregnated fiber and is disposed radially inward. The outer laminated section includes a winding end of the impregnated fiber and is disposed radially outward. The intermediate laminated section is formed between the inner laminated section and the outer laminated section. First and second dome portions of a liner are respectively provided with first and second core materials between the inner laminated section and the outer laminated section.

### CROSS-REFERENCE TO RELATED APPLICATIONS

This application is based upon and claims the benefit of priority from Japanese Patent Application No. 2021-061641 filed on Mar. 31, 2021, the contents of which are incorporated herein by reference.

### BACKGROUND OF THE INVENTION

### Field of the Invention

The present invention relates to a high pressure tank provided with a reinforcement layer covering the outer peripheral surface of a liner made of a resin material, and a method for manufacturing the same.

### Description of the Related Art

The present applicant has proposed, in JP 2020-070907 A, a high pressure tank capable of filling the inside with high pressure gas such as hydrogen gas. The high pressure tank includes a liner and an FRP layer. The high pressure tank has a two-layer structure consisting of a liner and an FRP layer. The liner is formed from a resin material. The liner is located most radially inward in the high pressure tank. The FRP layer is disposed radially outward of the liner. Both ends of the high pressure tank in its axial direction are respectively provided with caps. A reinforcement layer is formed by winding a resin-impregnated reinforced fiber around the outer wall of the liner plural times. In the reinforcement layer, a helical layer and a hoop layer are laminated. The winding direction of reinforced fiber in the helical layer and the winding direction of reinforced fiber in the hoop layer are different. After the helical layer and the hoop layer are laminated, the reinforced fiber is heated and cured. Thus, the reinforcement layer is formed.

### SUMMARY OF THE INVENTION

In a high pressure tank, it is desirable to reduce the amount of fiber used in the reinforcement layer, thereby reducing the manufacturing cost and weight.

According to an aspect of the present invention, a high pressure tank includes a hollow liner made of a resin material, and a reinforcement layer which covers an outer surface of the liner by winding a fiber around the outer surface of the liner a plurality of times, and the liner includes a cylindrical body portion and curved portions arranged at both ends of the body portion in an axial direction thereof. The reinforcement layer includes an inner laminated section which includes a winding start of the fiber and in which a helical layer disposed radially inward is laminated an outer laminated section which includes a winding end of the fiber and in which a helical layer disposed radially outward is laminated, and an intermediate laminated section which is disposed between the inner laminated section and the outer laminated section and includes at least one hoop layer, and in regions of the reinforcement layer covering the curved portions, core materials are arranged between the inner laminated section and the outer laminated section, and in places ranging from the intermediate laminated section toward the curved portions.

According to the present invention, the core members (core materials) are arranged between the inner laminated section and the outer laminated section in the regions of the reinforcement layer covering the curved portions of the liner. That is, the core members are arranged in each portion corresponding to the intermediate laminated section where the load to be borne is small in each of the curved portions. When the liner is expanded by the high pressure gas filling inside the high pressure tank and a load is applied to each of the curved portions, the inner laminated section and the outer laminated section preferably bear the load. As compared with the case where the intermediate laminated section is provided in each of the curved portions, the use of fiber in each of the curved portions can be reduced by arranging the core member instead. As a result, the production cost of the high pressure tank can be reduced by reducing the amount of fiber used, by providing the core members instead of the intermediate laminated section, while maintaining the load bearing performance in the curved portions. It is also possible to reduce the weight of high pressure tank by reducing the amount of fiber used.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall sectional view of a high pressure tank according to an embodiment of the present invention;

FIG. 2 is an enlarged sectional view illustrating a cap of the high pressure tank shown in FIG. 1 and the vicinity of a first dome portion;

FIG. 3 is a front view illustrating a state in which a first core member is attached to the high pressure tank of FIG. 1;

FIG. 4A is an enlarged cross-sectional view illustrating a state in which an inner laminated section and the intermediate laminated section are laminated on a liner and a divided core is mounted thereon;

FIG. 4B is an enlarged cross-sectional view illustrating a state in which an outer laminated section starts to be laminated on the liner of FIG. 4A;

FIG. 4C is an enlarged cross-sectional view illustrating a state in which the first dome portion and the first core member are completely covered with the outer laminated section with respect to the liner of FIG. 4B;

FIG. 5 is an enlarged sectional view illustrating the cap and the vicinity of the first dome portion of the high pressure tank according to a first modification;

FIG. 6 is an enlarged sectional view illustrating the cap and the vicinity of the first dome portion of the high pressure tank according to a second modification; and

FIG. 7 is an enlarged cross-sectional view illustrating the vicinity of the second dome portion of the high pressure tank according to a third modification.

### DESCRIPTION OF THE INVENTION

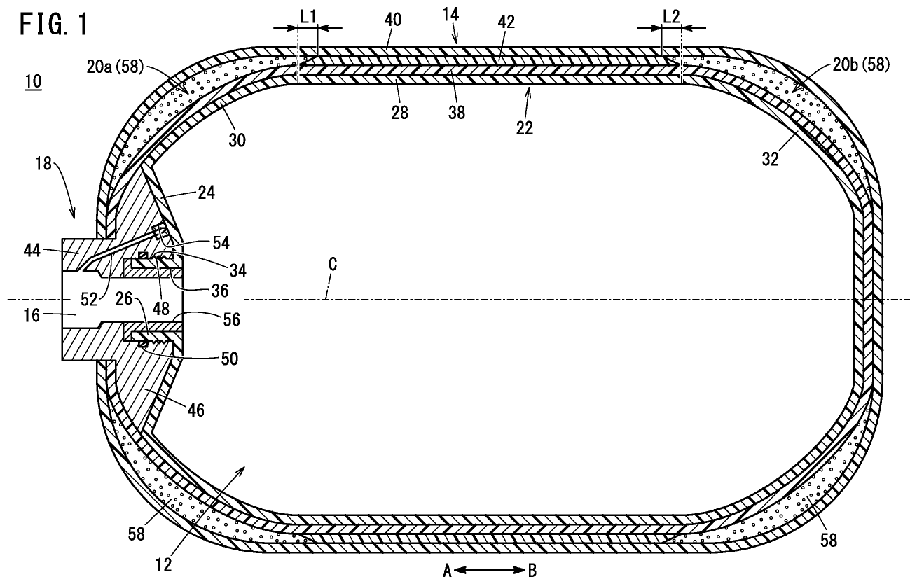

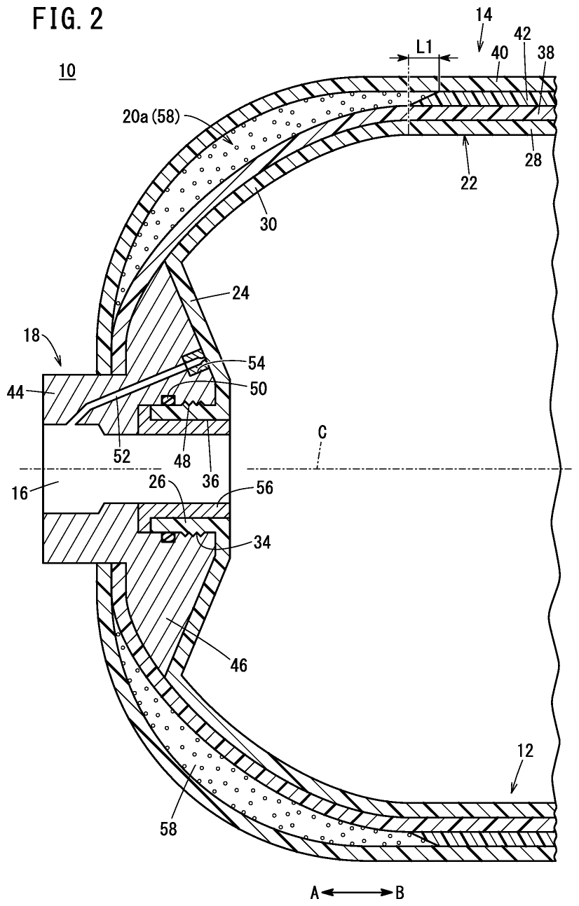

A high pressure tank 10 is used for the purpose of storing hydrogen gas. The high pressure tank 10 is mounted in a fuel cell vehicle. The high pressure tank 10 stores hydrogen gas that is supplied to a fuel cell system. As shown in FIGS. 1 and 2, the high pressure tank 10 includes a liner 12, a reinforcement layer 14, a cap 18, and first and second core members (core materials) 20a and 20b. The reinforcement layer 14 is an outer layer covering the outer periphery of the liner 12. The cap 18 has a vent (or a supply and discharge hole) 16 and is connected to one end of the liner 12 in the axial direction. The first and second core members (core materials) 20a and 20b are disposed inside the reinforcement layer 14.

The liner 12 is an inner layer of the high pressure tank 10. The liner 12 is a hollow body that is formed of a resin material. A high pressure gas such as a hydrogen gas can be accommodated inside of the liner 12. The liner 12 includes a main body portion 22, a concave portion 24, and a tubular portion 26. In the following description, a case where the inside of the high pressure tank 10 is filled with hydrogen gas will be described. The concave portion 24 is arranged at one end of the main body portion 22 in the axial direction. The concave portion 24 is recessed toward the inside of the main body portion 22. The tubular portion 26 protrudes from the concave portion 24 toward the outside of the main body portion 22.

The outer surface of the main body portion 22 is covered with the reinforcement layer 14. The main body portion 22 includes a cylindrical portion (body portion) 28, a first dome portion (curved portion) 30, and a second dome portion (curved portion) 32. The cylindrical portion 28 has a substantially cylindrical shape. An inner diameter and an outer diameter of the cylindrical portion 28 are substantially constant along the axial direction (directions of arrows A and B), respectively.

The first dome portion 30 is arranged at one end of the cylindrical portion 28 in the axial direction. The first dome portion 30 is gradually curved radially inward toward a tip of the cylindrical portion 28. The cross-sectional shape of the first dome portion 30 is a curved shape whose diameter gradually decreases in the direction away from the cylindrical portion 28 (the direction of arrow A). The first dome portion 30 is connected to the concave portion 24.

The second dome portion 32 is arranged at another axial end of the cylindrical portion 28. The second dome portion 32 is gradually curved radially inward toward a tip of the cylindrical portion 28. The cross-sectional shape of the second dome portion 32 is a curved shape whose diameter gradually decreases in the direction away from the cylindrical portion 28 (the direction of arrow B).

Two dot chain lines shown in FIG. 1 indicate a boundary between the first dome portion 30 and the cylindrical portion 28, and a boundary between the second dome portion 32 and the cylindrical portion 28.

The tubular portion 26 projects from a bottom portion of the concave portion 24 toward one end of the liner 12 in the axial direction by a predetermined length. An outer peripheral surface of the tubular portion 26 includes a male screw portion 34. A through hole 36 is provided inside the tubular portion 26. The through hole 36 penetrates the tubular portion 26 in the axial direction (directions of arrows A and B). The through hole 36 communicates with the inside of the main body portion 22.

The reinforcement layer 14 is formed of fiber reinforced resin (FRP) in which the fiber is impregnated with a resin base material. In the manufacturing process of the high pressure tank 10, the reinforced fiber (or fibers) impregnated with resin (hereinafter referred to as impregnated fiber) is wound around an outer peripheral surface of the liner 12 a plurality of times by a filament winding device (not shown). The reinforcement layer 14 is a laminated body in which the impregnated fiber is wound around the liner 12 and thereafter heated to cure the resin.

The reinforcement layer 14 includes an inner laminated section 38, an outer laminated section 40, and an intermediate laminated section 42. The inner laminated section 38 includes a winding start of the impregnated fiber and forms a radially inner side of the reinforcement layer 14. The outer laminated section 40 includes a winding end of the impregnated fiber and forms a radially outer side of the reinforcement layer 14. The outer laminated section 40 is disposed radially outward from the inner laminated section 38. The intermediate laminated section 42 is disposed between the inner laminated section 38 and the outer laminated section 40.

The inner laminated section 38 and the outer laminated section 40 each form a laminated body in which the impregnated fiber is wound in a low helical manner. The helical winding is a winding method in which the impregnated fiber is wound around the liner 12 in a state where an extending direction of the impregnated fiber is inclined at a predetermined inclination angle θ with respect to the axial direction (axis C in FIGS. 1 and 2) of the cylindrical portion 28 of the liner 12. In the present embodiment, low helical winding refers to a case where the inclination angle θ is about 40° or less (θ≤40°). High helical winding refers to a case where the inclination angle θ exceeds about 40° (θ>40°).

The inner laminated section 38 and the outer laminated section 40 are each composed of a laminated body in the low helical winding. Thus, the outer peripheral surfaces of the cylindrical portion 28, the first dome portion 30, and the second dome portion 32 constituting the liner 12 are respectively covered with the impregnated fiber. The inner laminated section 38 and the outer laminated section 40 each cover the first dome portion 30 in the vicinity of one axial end of the liner 12. One axial end of the inner laminated section 38 and one axial end of the outer laminated section 40 are respectively connected to the outer peripheral surface of the cap 18. The one axial end of the inner laminated section 38 and the one axial end of the outer laminated section 40 are connected to each other in the axial direction of the high pressure tank 10 (in the directions of arrows A and B).

By covering the outer peripheral surface of the liner 12 with the impregnated fiber of the low helical winding, an exposed area of the liner 12 can be made smaller than when the outer peripheral surface of the liner 12 is covered with the impregnated fiber in the high helical winding. Therefore, in the high pressure tank 10, the pressure capacity of the first and second dome portions 30 and 32 is secured by the reinforcement layer 14.

The intermediate laminated section 42 is a hoop layer in which the impregnated fiber is wound mainly in a hoop winding manner. The hoop winding is a winding method in which the extending direction of the impregnated fiber is wound in a direction substantially orthogonal to the axial direction (axis C in FIGS. 1 and 2) of the cylindrical portion 28 of the liner 12.

The cap 18 is formed from a metal material. The cap 18 includes a cap main body 44 and a flange portion 46. The cap main body 44 has a cylindrical shape. The inside of the cap main body 44 has the supply and discharge hole 16. The supply and discharge hole 16 is disposed in the center of the cap main body 44. The supply and discharge hole 16 penetrates along the axial direction (directions of arrows A and B) of the cap main body 44. The flange portion 46 extends radially outward and substantially orthogonal to the cap main body 44.

The distal end of the supply and discharge hole 16 opens. A pipe (not shown) or the like is connected to a tip end of the cap main body 44. The pipe and the like communicate with the supply and discharge hole 16. The proximal end of the supply and discharge hole 16 is an end portion toward the liner 12. An inner peripheral surface of the proximal end of the supply and discharge hole 16 has a screw hole 48. The screw hole 48 has a female screw. An O-ring 50 is attached to the supply and discharge hole 16 through an annular groove at a position closer to a tip end than the screw hole 48 is.

The cap main body 44 includes a discharge passage 52. The discharge passage 52 extends substantially in parallel to the supply and discharge hole 16. The discharge passage 52 is disposed outside the supply and discharge hole 16 in the cap main body 44. The discharge passage 52 communicates with an insertion hole 54. The insertion hole 54 opens in an end face facing the liner 12 at the flange portion 46. At the tip end of the cap main body 44, the discharge passage 52 and the supply and discharge hole 16 communicate with each other.

The flange portion 46 of the cap 18 is received in the concave portion 24. The flange portion 46 covers the concave portion 24. The tubular portion 26 of the liner 12 is inserted into the screw hole 48 of the cap main body 44. The screw hole 48 and the male screw portion 34 are screwed together. At this time, the O-ring 50 is held between the tubular portion 26 and the cap main body 44. The tubular portion 26 and the cap main body 44 are sealed by the O-ring 50.

Thus, when the cap 18 is coaxially mounted on one axial end of the liner 12, the flange portion 46 is covered with the reinforcement layer 14 together with the liner 12. The tip end of the cap main body 44 protrudes outward from the reinforcement layer 14 by a predetermined length. The tip end of the cap main body 44 is exposed to the outside.

A collar member 56 is mounted inside the supply and discharge hole 16. The collar member 56 is formed of a metal material and has a cylindrical shape. A portion of the collar member 56 is inserted into the inside of the tubular portion 26 of the liner 12. An end portion of the collar member 56 is provided with a flange portion. The flange portion is held between the tubular portion 26 and the supply and discharge hole 16. Thus, the collar member 56 and the tubular portion 26 are fixed coaxially. The through hole 36 of the liner 12 communicates with the supply and discharge hole 16 through the interior of the collar member 56.

As shown in FIGS. 1 to 4C, the first and second core members 20a and 20b are made of, for example, a porous or honeycomb metallic material. In a region of the reinforcement layer 14 covering the first dome section 30, the first core member 20a is arranged between the inner laminated section 38 and the outer laminated section 40. The first core member 20a is in close contact with an outer surface of the inner laminated section 38 and an inner surface of the outer laminated section 40, respectively. The first core member 20a is bonded to the outer surface of the inner laminated section 38 and the inner surface of the outer laminated section 40, respectively.

In a region of the reinforcement layer 14 covering the second dome portion 32, the second core member 20b is arranged between the inner laminated section 38 and the outer laminated section 40. The second core member 20b is in close contact with the outer surface of the inner laminated section 38 and the inner surface of the outer laminated section 40, respectively. The second core member 20b is bonded to the outer surface of the inner laminated section 38 and the inner surface of the outer laminated section 40, respectively.

The first core member 20a is mounted on the first dome portion 30 in place of the intermediate laminated section 42. The second core member 20b is mounted on the second dome portion 32 in place of the intermediate laminated section 42. The thickness of the first and second core members 20a and 20b is substantially the same as or slightly thicker than the thickness of the intermediate laminated section 42.

In the cross-section of the high pressure tank 10 shown in FIG. 1, the thickness of the first core member 20a in the radial direction is maximum at a substantially central portion along the extending direction of the first core member 20a.

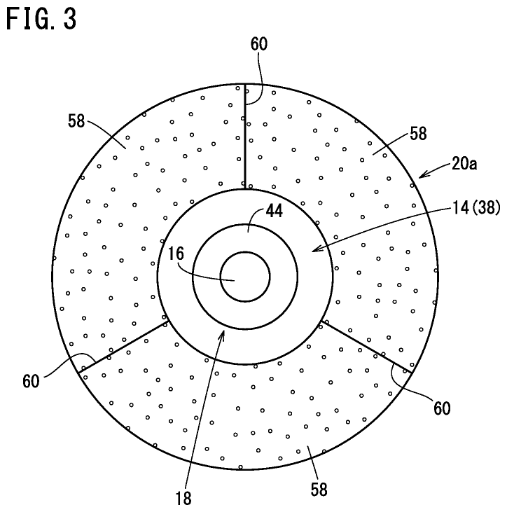

As shown in FIG. 3, the first core member 20a has a plurality of divided cores 58. The plurality of divided cores 58 can be divided in a circumferential direction of the liner 12. The respective divided cores 58 are arranged radially outward with respect to the axial center of the first dome portion 30. The respective divided cores 58 are arranged so as to be close to each other in the circumferential direction of the first dome portion 30. The plurality of divided cores 58 are arranged close to each other in the circumferential direction of the first dome portion 30. The plurality of divided cores 58 come to contact each other in the circumferential direction to form the annular first core member 20a. The first core member 20a is not limited to the configuration that can be divided in the circumferential direction as described above. The first core member 20a may have an annular shape integrally formed in the circumferential direction.

The cross-sectional shape of the first core member 20a is an arc shape as shown in FIGS. 1 and 2. The cross-sectional shape of the first core member 20a corresponds to the outer surface shape of the inner laminated section 38 wound around the first dome portion 30. One end of the first core member 20a in the axial direction is curved radially inward toward the cap 18. The one axial end of the first core member 20a is arranged radially outward from the cap 18 by a predetermined distance. The one axial end of the first core member 20a is surrounded by one axial end of the inner laminated section 38 and one axial end of the outer laminated section 40.

The second core member 20b has a plurality of divided cores 58. The plurality of divided cores 58 can be divided in the circumferential direction of the liner 12. The respective divided cores 58 are arranged radially outward with respect to the axial center of the second dome portion 32. The respective divided cores 58 are arranged so as to be close to each other in the circumferential direction of the second dome portion 32. The plurality of divided cores 58 are arranged close to each other in the circumferential direction of the second dome portion 32. The plurality of divided cores 58 come to contact each other in the circumferential direction to form the annular second core member 20b.

In the cross-section of the high pressure tank 10 shown in FIG. 1, the thickness of the second core member 20b in the radial direction is maximum at a substantially central portion along the extending direction of the second core member 20b. The second core member 20b is not limited to the configuration that can be divided in the circumferential direction as described above. The second core member 20b may have an annular shape integrally formed in the circumferential direction.

The cross-sectional shape of the second core member 20b is an arc shape as shown in FIG. 1. The cross-sectional shape of the second core member 20b corresponds to the outer surface shape of the inner laminated section 38 wound around the second dome portion 32. Another end of the second core member 20b in the axial direction is curved radially inward. The second core member 20b and the first core member 20a have substantially the same shape. The other axial end of the second core member 20b is surrounded by the other axial end of the inner laminated section 38 and the outer laminated section 40.

As shown in FIGS. 1 and 2, another axial end of the first core member 20a projects toward the second dome portion 32 by a predetermined distance L1 from another axial end of the first dome portion 30. The other axial end of the first core member 20a is arranged at a position overlapping the cylindrical portion 28. The other axial end of the first core member 20a and one axial end of the intermediate laminated section 42 are contiguously connected.

The thickness of the other end of the first core member 20a in the axial direction and the thickness of the intermediate laminated section 42 are substantially the same. The outer surface of the other end of the first core member 20a in the axial direction and the outer surface of the intermediate laminated section 42 are substantially the same plane.

As shown in FIG. 1, one end of the second core member 20b in the axial direction projects toward the first dome portion 30 by a predetermined distance L2 from one end of the second dome portion 32 in the axial direction. The one axial end of the second core member 20b is arranged at a position overlapping the cylindrical portion 28. The one axial end of the second core member 20b and the other axial end of the intermediate laminated section 42 are contiguously connected.

The thickness of one end of the second core member 20b in the axial direction and the thickness of the intermediate laminated section 42 are substantially the same. The outer surface of one axial end of the second core member 20b and the outer surface of the intermediate laminated section 42 are substantially the same plane.

The first and second core members 20a and 20b are formed of a porous or honeycomb metallic material. Thus, it is possible to enhance the interfacial bond strength between the first and second core members 20a and 20b and the inner laminated section 38 and the outer laminated section 40.

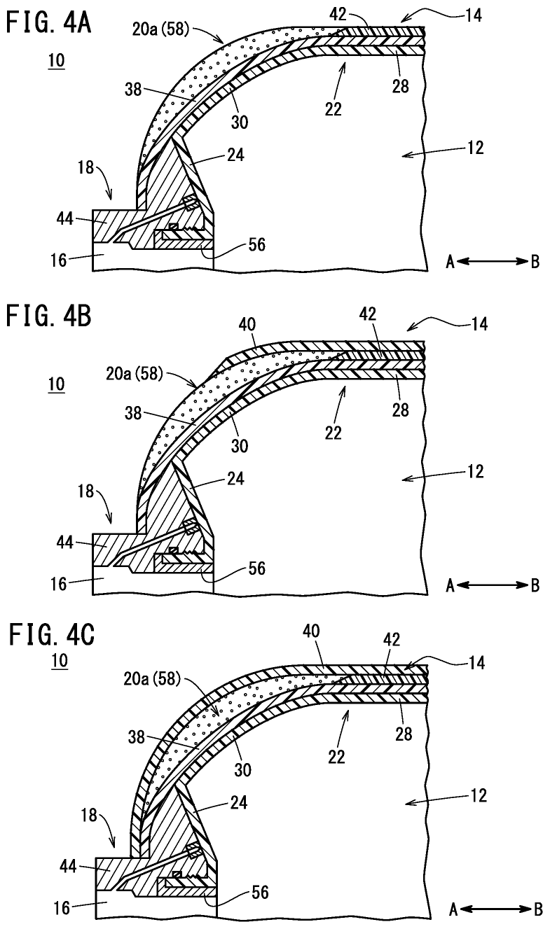

Next, a case where the high pressure tank 10 is manufactured by a filament winding device (not shown) will be described with reference to FIGS. 4A to 4C. Since the filament winding device is publicly known, a detailed description thereof will be omitted.

First, as shown in FIGS. 1 and 4A, the flange portion 46 of the cap 18 is attached to the concave portion 24 of the liner 12. The impregnated fiber is wound on an outer peripheral surface of the liner 12 a plurality of times from the other axial end of the liner 12 to the one axial end thereof. Thus, the inner laminated section 38 is formed so as to cover the whole of the cylindrical portion 28, the first and second dome portions 30 and 32 of the liner 12 (first lamination step). The inner laminated section 38 is formed with a predetermined thickness on the outer peripheral surface of the liner 12. The inner laminated section 38 is a low helical layer (first helical layer) in which an impregnated fiber is wound around the outer peripheral surface of the liner 12 in the low helical winding.

Next, the impregnated fiber is wound a plurality of times on the outside of the inner laminated section 38 covering the outer peripheral surface of the liner 12. The impregnated fiber is wound a plurality of times from the other end of the liner 12 in the axial direction toward the one end in the axial direction within the range of the outer periphery of the cylindrical portion 28. Thus, the intermediate laminated section 42 is formed so as to cover the cylindrical portion 28. The intermediate laminated section 42 is formed with a predetermined thickness on the outer peripheral surface of the inner laminated section 38. The intermediate laminated section 42 is formed in the axial direction of the cylindrical portion 28 from the other axial end to the one axial end, and covers the cylindrical portion 28. The intermediate laminated section 42 is not formed on the first and second dome portions 30 and 32. The first and second dome portions 30, 32 are not covered by the intermediate laminated section 42. Therefore, the first and second dome portions 30, 32 are covered only by the inner laminated section 38 there. In the intermediate laminated section 42, the impregnated fiber is wound in the hoop winding which is performed substantially perpendicular to the axis of the liner 12. The intermediate laminated section 42 is at least one hoop layer.

As shown in FIG. 4A, the outer peripheral surface of the first dome portion 30 is covered by the inner laminated section 38. The divided cores 58 of the first core member 20a are mounted on the outer peripheral surface of the inner laminated section 38. An outer peripheral surface of the second dome portion 32 is covered by the inner laminated section 38. The divided cores 58 of the second core member 20b are mounted on the outer peripheral surface of the inner laminated section 38 (arrangement step). Each of the divided cores 58 is arranged radially outward of the inner laminated section 38.

Specifically, as shown in FIGS. 2 and 3, an inner surface of each of the divided cores 58, which are concave, faces the inner laminated section 38. The divided cores 58 are brought close from the outer periphery of the inner laminated section 38 (first dome portion 30) toward the liner 12 in the radial direction. By bringing each divided core 58 close to the liner 12, the divided cores 58 are brought close to each other in the circumferential direction of the liner 12. Divided surfaces 60 of two adjacent divided cores 58 contact each other. As a result, the two divided cores 58 are connected in the circumferential direction, to form the annular first core member 20a. The inner surface of the first core member 20a is brought into close contact with the outer peripheral surface of the inner laminated section 38.

The one axial end of the first core member 20a is disposed along one axial end of the inner laminated section 38 and one axial end of the liner 12, away from the cap 18 radially outward by a predetermined distance. The other axial end of the first core member 20a is connected to the one axial end of the intermediate laminated section 42 so as to be in close contact and contiguous thereto.

The second core member 20b makes the inner surfaces of the three divided cores 58 face the inner laminated section 38 of the second dome portion 32. The divided cores 58 are made to approach radially inward toward the liner 12 from the outer periphery of the inner laminated section 38 (second dome portion 32). As each divided core 58 moves toward the liner 12, the divided cores 58 approach each other in the circumferential direction of the liner 12. The divided surfaces 60 of two adjacent divided cores 58 contact each other. As a result, the two divided cores 58 are connected in the circumferential direction, to form the annular second core member 20b. The inner surfaces of the second core members 20b are brought into close contact to the outer peripheral surface of the inner laminated section 38.

The other axial end of the second core member 20b is disposed along the other axial ends of the inner laminated section 38 and the liner 12, away from the axial center of the second dome section 32 radially outward by a predetermined distance. The one axial end of the second core member 20b is connected to the other axial end of the intermediate laminated section 42 so as to be in close contact and contiguous thereto.

Each of the first and second core members 20a and 20b is made up of the three divided cores 58. As shown in FIGS. 1 and 4A, the first core member 20a completely covers the inner laminated section 38 of the first dome portion 30. The second core member 20b completely covers the inner laminated section 38 of the second dome portion 32. The outer peripheral surface of the first core member 20a and the outer peripheral surface of the intermediate laminated section 42 are connected in substantially the same plane. The outer peripheral surface of the second core member 20b and the outer peripheral surface of the intermediate laminated section 42 are connected in substantially the same plane. In this manner, each of the first and second core members 20a and 20b has a dividable configuration including a plurality of divided cores 58. Therefore, when the liner 12 is attached to a filament winding device (not shown), the first and second core members 20a and 20b can be easily and reliably mounted on the outer peripheral surface of the liner 12.

Next, as shown in FIGS. 1 and 4B, the impregnated fiber is wound a plurality of times from the other axial end of the liner 12 toward one axial end (in the direction of arrow A). Thus, the outer peripheries of the intermediate laminated section 42 and the first and second core members 20a and 20b are covered by the impregnated fiber. The outer laminated section 40 covering the outer peripheries of the first and second core members 20a and 20b is formed (second lamination step). In other words, the outer laminated section 40 is formed by winding the impregnated fiber around the outer periphery of the cylindrical portion 28 on which the inner laminated section 38 and the intermediate laminated section 42 are laminated. The outer laminated section 40 is wound and laminated around the outer periphery of the inner laminated section 38 and the outer peripheries of the first and second core members 20a and 20b.

The outer laminated section 40 is a low helical layer (second helical layer) formed by winding the impregnated fiber in a low helical winding radially outward of the liner 12. The outer laminated section 40 may be laminated by high helical winding so as to cover the vicinity of the boundaries between the first and second dome portions 30, 32 and the cylindrical portion 28. Thus, the first and second core members 20a and 20b can be firmly fixed at predetermined positions in the first and second dome portions 30 and 32 of the liner 12.

Next, as shown in FIGS. 1, 2 and 4C, the inner laminated section 38, the intermediate laminated section 42, and the outer laminated section 40 are laminated on the outer peripheral surface of the liner 12. The first core member 20a is housed between the inner laminated section 38 and the outer laminated section 40 in the first dome portion 30. The second core member 20b is housed between the inner laminated section 38 and the outer laminated section 40 in the second dome portion 32. By heating the high pressure tank 10 including the liner 12, the resin of the impregnated fiber in the inner laminated section 38, the intermediate laminated section 42, and the outer laminated section 40 is cured. The reinforcement layer 14 provided with plural layers, including the inner laminated section 38, the intermediate laminated section 42, and the outer laminated section 40, is formed on the outer periphery of the liner 12. The manufacturing of the high pressure tank 10 is completed, in which the outer periphery of the liner 12 is covered with the reinforcement layer 14 made up of plural layers.

Next, the operation of the high pressure tank 10 will be briefly described.

First, when hydrogen gas is stored in the high pressure tank 10, the hydrogen gas is supplied through a pipe (not shown) or the like to the supply and discharge hole 16 of the cap 18. The hydrogen gas is introduced into the hollow inside of the liner 12 through the supply and discharge hole 16 and the collar member 56. The inside of the liner 12 is filled with the hydrogen gas.

At this time, in the liner 12, an internal pressure gradually increases due to the hydrogen gas. As the internal pressure of the liner 12 increases, the liner 12 expands slightly toward the outer periphery. When the main body portion 22 (the cylindrical portion 28, the first and second dome portions 30, 32) of the liner 12 is deformed toward the outer periphery, the reinforcement layer 14 is pressed outward in the radial direction by the main body portion 22.

When the main body portion 22 is deformed toward the reinforcement layer 14, a load is applied to the cylindrical portion 28 in a radially outward direction orthogonal to the axial direction of the liner 12. Loads are also applied to the first and second dome portions 30, 32 from the inside of the liner 12 toward the outer peripheral side. The first and second dome portions 30, 32 are deformed in the expanding direction by the loads. At this time, the loads applied from the liner 12 to the reinforcement layer 14 are mainly borne by the inner laminated section 38 in the fiber direction thereof, which is closest to the liner 12 outside in the radial direction of the liner 12. Each of the loads borne by the outer laminated section 40 and the intermediate laminated section 42 in the fiber direction is smaller than the load borne by the inner laminated section 38.

When the cap 18 is displaced in the axial direction due to the internal pressure of the hydrogen gas, a bending moment acts on the first dome portion 30. The load which generates the bending moment is mainly borne by the inner laminated section 38 that is closest to the liner 12 on the radially outer side of the liner 12 and the outer laminated section 40 disposed on the radially outermost side thereof.

The first and second core members 20a, 20b are formed of a porous or honeycomb metallic material. Thus, it is possible to enhance the interfacial adhesion strength between the first and second core members 20a, 20b and the inner laminated section 38 and the outer laminated section 40 made of the impregnated fiber. Therefore, when filling the high pressure tank (10) with hydrogen gas, the loads applied through the pressure of the hydrogen gas to the first and second dome portions 30, 32 can be borne by the respective first and second core members 20a, 20b in addition to the inner laminated section 38 and the outer laminated section 40.

When only the inner laminated section 38 and the outer laminated section 40 are required to bear the loads respectively applied to the first and second dome portions 30 and 32, the first and second core members 20a and 20b may be formed of, for example, a polymer foam, a non-woven fabric, and the like. That is, the first and second core members 20a and 20b need not be formed of the porous or honeycomb metallic material.

Next, the hydrogen gas stored in the high pressure tank 10 is discharged to the outside through the supply and discharge hole 16. The hydrogen gas is discharged from the hollow inside of the liner 12 through the collar member 56 and the supply and discharge hole 16 to the outside. As the hydrogen gas is discharged, the internal pressure of the liner 12 decreases. Then, the liner 12 contracts slightly radially inward.

In this embodiment, the high pressure tank 10 includes the liner 12 and the reinforcement layer 14. The liner 12 is made of a resin material and formed into a hollow shape. In the reinforcement layer 14, the impregnated fiber is wound on the outer surface of the liner 12 a plurality of times. The reinforcement layer 14 covers the outer surface of the liner 12. The liner 12 has the cylindrical portion 28 and the first and second dome portions 30, 32. The first and second dome portions 30, 32 are disposed at both axial ends of the cylindrical portion 28, respectively. The reinforcement layer 14 includes the inner laminated section 38, the outer laminated section 40, and the intermediate laminated section 42. The inner laminated section 38 includes a winding start of the impregnated fiber on the liner 12 and includes a helical layer disposed radially inward. The outer laminated section 40 includes a winding end of the impregnated fiber for the liner 12 and includes a helical layer disposed radially outward. The intermediate laminated section 42 is disposed between the inner laminated section 38 and the outer laminated section 40. The intermediate laminated section 42 includes at least one hoop layer. In the first and second dome portions 30, 32, the respective first and second core members 20a, 20b are arranged between the inner laminated section 38 and the outer laminated section 40.

The inside of the high pressure tank 10 is filled with hydrogen gas, and the internal pressure of the liner 12 is increased by the hydrogen gas so that the liner 12 expands. As the liner 12 expands, a load is applied to the liner 12 radially outward of the liner 12. At this time, the first and second core members 20a and 20b are arranged between the inner laminated section 38 and the outer laminated section 40, in the first and second dome portions 30 and 32. In other words, the first and second core members 20a and 20b are arranged at positions corresponding to the intermediate laminated section 42 where the load to be borne is small. Thus, when the first and second dome portions 30, 32 expand to apply loads, the inner laminated section 38 and the outer laminated section 40 suitably bear the loads. By arranging the first and second core members 20a and 20b in place of the intermediate laminated section 42, the amount of impregnated fiber used can be reduced. That is, it is possible to reduce the amount of the impregnated fiber used while maintaining the load bearing performance by the inner laminated section 38 and the outer laminated section 40.

As a result, the amount of impregnated fiber used in the first and second dome sections 30, 32 can be reduced, compared to the case where the first and second dome portions 30, 32 of the liner 12 are covered with the reinforcement layer 14 having three layers that are the inner laminated section 38, the outer laminated section 40, and the intermediate laminated section 42. Therefore, the manufacturing cost of the high pressure tank 10 can be reduced. Also, it is possible to reduce the weight of the high pressure tank 10.

The first and second core members 20a, 20b are arranged along the inner laminated section 38 of the first and second dome portions 30, 32, respectively. Then, the first and second core members 20a, 20b are respectively connected to the one axial end and the other axial end of the intermediate laminated section 42 so as to be continuous thereto. As a result, the outer surfaces of the first and second core members 20a and 20b and the outer surface of the intermediate laminated section 42 are connected so as to have a continuous surface without any step. Therefore, when the impregnated fiber is wound around the outer surfaces of the first and second core members 20a and 20b and the intermediate laminated section 42, the meandering of the impregnated fiber due to the above-described step can be reduced.

As a result, the impregnated fiber can be wound around the outer surfaces of the first and second core members 20a and 20b and the intermediate laminated section 42 to form the outer laminated section 40. When the impregnated fiber is wound around the outer surfaces of the first and second core members 20a, 20b and the intermediate laminated section 42, it is possible to prevent the impregnated fiber from meandering, thereby preventing the strength reduction of the reinforcement layer 14. Also, it is possible to cover the outer peripheral surface of the liner 12 by the reinforcement layer 14 having a desired strength.

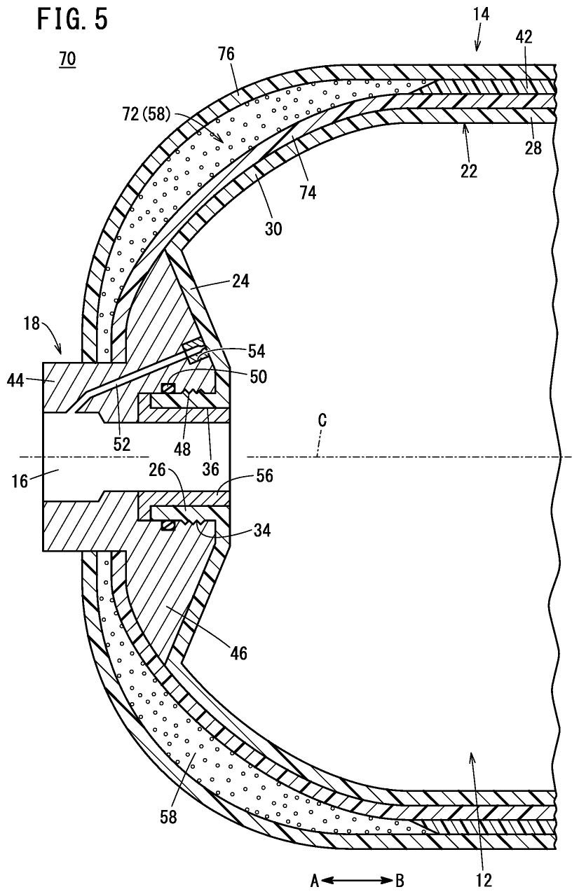

A high pressure tank 70 according to a first modification shown in FIG. 5 may be used. The high pressure tank 70 includes a first core member (core material) 72. The first core member 72 is disposed radially outward of the first dome portion 30 of the liner 12. One end of the first core member 72 in the axial direction extends to the outer peripheral surface of the cap 18. The one axial end of the first core member 72 is laminated in the axial direction (in the directions of arrows A and B) between one axial end of an inner laminated section 74 and one axial end of an outer laminated section 76.

By providing the high pressure tank 70 with the first core member 72, it is possible to reduce the amount of impregnated fiber used in the inner laminated section 74 and the outer laminated section 76 at the one axial end of the reinforcement layer 14, as compared to the amount in the high pressure tank 10. Therefore, the high pressure tank 70 according to the first modification can reduce the weight even more than the high pressure tank 10. The manufacturing cost of the high pressure tank 70 can be reduced compared to that of the high pressure tank 10.

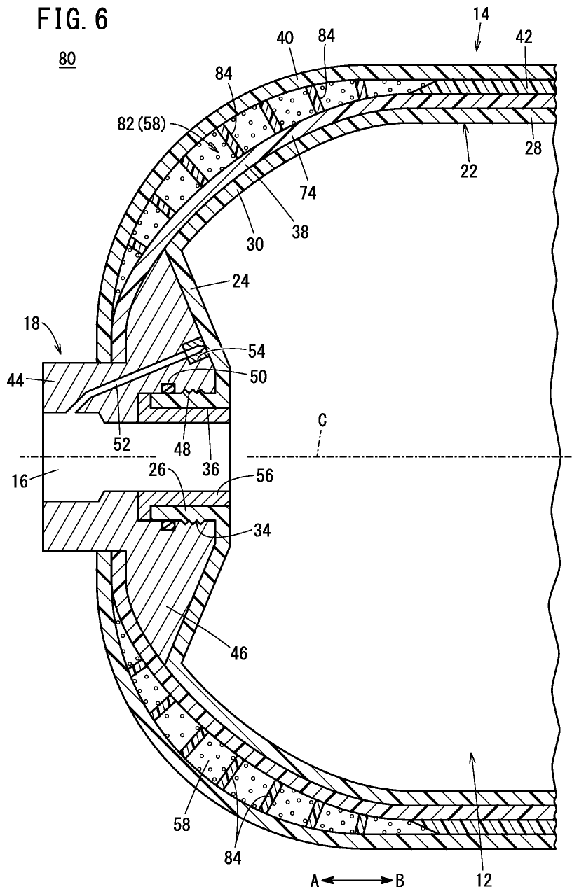

A high pressure tank 80 according to a second modification shown in FIG. 6 may be used. The high pressure tank 80 includes a first core member (core material) 82. A plurality of supporting posts (connecting members) 84 are provided inside the first core member 82. The plurality of supporting posts 84 connect the inner laminated section 38 and the outer laminated section 40. The plurality of supporting posts 84 are formed of a fiber or resin material. The plurality of supporting posts 84 extend in the thickness direction of the inner laminated section 38 and the outer laminated section 40. One end of each of the plurality of supporting posts 84 is in contact with the outer peripheral surface of the inner laminated section 38. The other end of each of the plurality of supporting posts 84 is in contact with the inner peripheral surface of the outer laminated section 40. Thus, the inner laminated section 38 and the outer laminated section 40 are supported by the plurality of supporting posts 84.

The plurality of supporting posts 84 are arranged along the inner laminated section 38 and the outer laminated section 40 at equal spaces. Also, the plurality of supporting posts 84 are spaced apart from each other along the circumferential direction of the first core member 82.

When the inside of the high pressure tank 80 is filled with hydrogen gas and a load caused by the internal pressure of the hydrogen gas is applied from the first dome portion 30 of the liner 12 to the inner laminated section 38, the load is transmitted from the inner laminated section 38 to the outer laminated section 40 via the plurality of supporting posts 84 of the first core member 82. Therefore, the load borne by the first core member 82 can be reduced. The weight of the high pressure tank 80 including the first core member 82 can be further reduced by making the plurality of supporting posts 84 out of polymer foam, non-woven fabric, or the like. By using the first core member 82, the manufacturing cost of the high pressure tank 80 can be reduced. Instead of disposing the core member having the plurality of supporting posts 84 as the first core member 82 in the first dome portion 30, it may be disposed as the second core member 20b in the second dome portion 32.

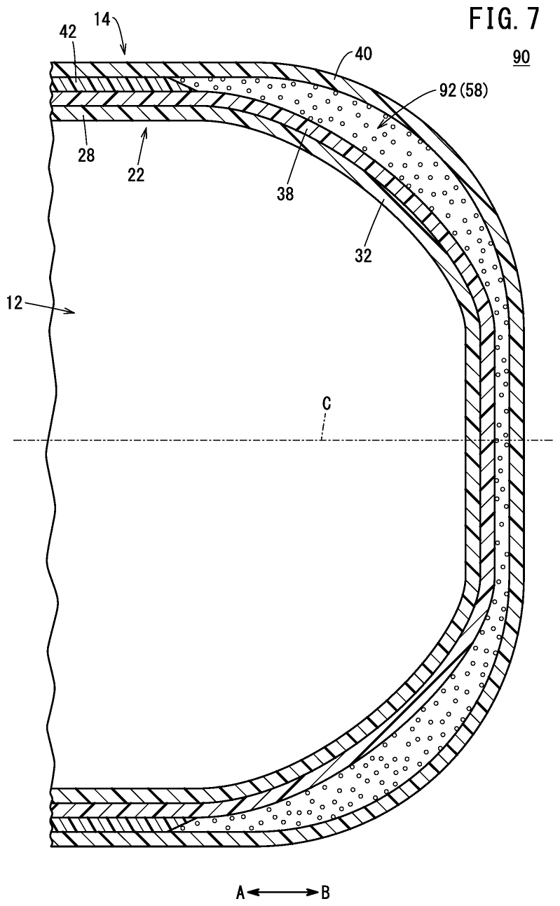

A high pressure tank 90 according to a third modification shown in FIG. 7 may be used. The high pressure tank 90 includes a second core member (core material) 92. The second core member 92 has three divided cores 58. Each of the divided cores 58 contacts each other radially inward. The three divided cores 58 cover the entire second dome portion 32. Compared to the high pressure tanks 10, 70, and 80, the high pressure tank 90 can further reduce the amount of impregnated fiber used in the reinforcement layer 14 covering the second dome portion 32. Therefore, the weight of the high pressure tank 90 can be further reduced. Also, the manufacturing cost of the high pressure tank 90 can be further reduced.

Each of the high pressure tanks 10, 70, 80, and 90 has a single-ended cap structure in which the cap 18 is connected only to one end of the liner 12 in the axial direction. Any of the first core members 20a, 72, 82 and any of the second core members 20b, 92 may be used in a high pressure tank having a double-ended cap structure in which the caps 18 are connected to one end and the other end of the liner 12 in the axial direction, respectively.

The above-described embodiments can be summarized in the following manner.

In the above embodiments, the high pressure tank (10, 70, 80, 90) includes the hollow liner (12) made of a resin material, and the reinforcement layer (14) which covers an outer surface of the liner by winding a fiber around the outer surface of the liner a plurality of times, and the liner includes the cylindrical body portion (22) and the pair of curved portions (30, 32) arranged at both ends of the body portion in an axial direction thereof. The reinforcement layer includes the inner laminated section (38, 74) which includes a winding start of the fiber and in which a helical layer disposed radially inward is laminated, the outer laminated section (40, 76) which includes a winding end of the fiber and in which a helical layer disposed radially outward is laminated, and the intermediate laminated section (42) which is disposed between the inner laminated section and the outer laminated section and includes at least one hoop layer, and in regions of the reinforcement layer covering the curved portions, the core materials (20a, 20b, 72, 92) are arranged between the inner laminated section and the outer laminated section, and in places ranging from the intermediate laminated section toward the curved portions.

Each of the core materials may be arranged along the inner laminated section and contiguously to the intermediate laminated section.

Each of the core materials may have a substantially cylindrical shape with a circular cross-section when viewed in the axial direction of the liner.

The number of layers of the inner laminated section and the number of layers of the outer laminated section may be substantially the same.

Each of the core materials may be provided with a connecting member (84) that connects the inner laminated section and the outer laminated section.

The method of manufacturing a high pressure tank is provided, the high pressure tank includes a hollow liner made of a resin material, and a reinforcement layer which covers an outer surface of the liner by winding a fiber around the outer surface of the liner a plurality of times, and the liner includes a cylindrical body portion and curved portions arranged at both ends of the body portion in an axial direction thereof. The method includes the first lamination step of laminating, by starting to wind the fiber around the liner, a first helical layer radially inward of the reinforcement layer to form an inner laminated section, the arrangement step of arranging a core material on an outer surface of the inner laminated section, and the second lamination step of laminating a second helical layer on an outer surface of the core material to form an outer laminated section.

The core material may include a plurality of divided cores divided in a circumferential direction of the liner, and in the arrangement step, the plurality of divided cores may be mounted on the inner laminated section.

The present invention is not limited to the above-described embodiments, and various configurations can be adopted therein without departing from the essence and gist of the present invention.

What is claimed is:

1. A high pressure tank comprising a hollow liner made of a resin material, and a reinforcement layer which covers an outer surface of the liner by winding a fiber around the outer surface of the liner a plurality of times, wherein the liner includes a cylindrical body portion and curved portions arranged at both ends of the body portion in an axial direction thereof,
wherein the reinforcement layer includes:
an inner laminated section which includes a winding start of the fiber and in which a helical layer disposed radially inward is laminated;
an outer laminated section which includes a winding end of the fiber and in which a helical layer disposed radially outward is laminated; and
an intermediate laminated section which is disposed between the inner laminated section and the outer laminated section and includes at least one hoop layer, and
wherein in regions of the reinforcement layer covering the curved portions, core materials are arranged between the inner laminated section and the outer laminated section, and in places ranging from the intermediate laminated section toward the curved portions.

2. The high pressure tank according to claim 1, wherein each of the core materials is arranged along the inner laminated section and contiguously to the intermediate laminated section.

3. The high pressure tank according to claim 1, wherein each of the core materials has a substantially cylindrical shape with a circular cross-section when viewed in the axial direction of the liner.

4. The high pressure tank according to claim 1, wherein a number of layers of the inner laminated section and a number of layers of the outer laminated section are substantially same.

5. The high pressure tank according to claim 1, wherein each of the core materials is provided with a connecting member that connects the inner laminated section and the outer laminated section.

6. A method of manufacturing a high pressure tank, the high pressure tank including a hollow liner made of a resin material, and a reinforcement layer which covers an outer surface of the liner by winding a fiber around the outer surface of the liner a plurality of times, wherein the liner includes a cylindrical body portion and curved portions arranged at both ends of the body portion in an axial direction thereof, the method comprising:
laminating, by starting to wind the fiber around the liner, a first helical layer radially inward of the reinforcement layer to form an inner laminated section;
arranging a core material on an outer surface of the inner laminated section; and
laminating a second helical layer on an outer surface of the core material to form an outer laminated section.

7. The method of manufacturing the high pressure tank according to claim 6,
wherein the core material includes a plurality of divided cores divided in a circumferential direction of the liner, and
in the arranging, the plurality of divided cores are mounted on the inner laminated section.
